(19) United States
(12) Patent Application Publication
(10) Pub. No.: US 2004/0022703 A1
(43) Pub. Date: Feb. 5, 2004

(54) Device for introducing a solid reagent

(75) Inventor: Michel Borgne, Trevoux (FR)

Correspondence Address: ROSS J. OEHLER, AVENTIS PHARMACEUTICALS INC., ROUTE 202-206, MAIL CODE: D303A, BRIDGEWATER, NJ, 08807, US

(73) Assignee: Aventis Pharma S.A., Antony (FR)

(21) Appl. No.: 10/452,586

(22) Filed: Jun. 2, 2003

(30) Foreign Application Priority Data
Jun. 3, 2002 (FR) FR 02 06782

(51) Int. Cl. B01J 8/08

(52) U.S. Cl. 422/232; 422/213

(57) ABSTRACT

Apparatus allowing a powdered reagent to be introduced into a reactor under a controlled atmosphere and allowing its introduction to be regulated as a function of time and traceability to be obtained.

The present invention relates to a system for introducing solids into a chemical reactor allowing control over the quantities introduced and especially providing awareness of the exact amount introduced over time and allowing the chemical reaction to be controlled as best as possible. In addition, this system makes it possible to have traceability of the introduction of the reagent by recording the mass of powder actually introduced. This apparatus for introducing solid reagents into a reactor therefore makes it possible to have regulated introduction of the solid that is also reproducible over time. This introduction can be performed under a controlled atmosphere.

### BACKGROUND OF THE INVENTION

The known systems generally consist in manually introducing the reagent regularly into the reactor, and this is not reproducible. It is difficult under these conditions to maintain the sealing of the reactor and the handling of dangerous products becomes very tricky. Systems for introducing powder are also known. The use of a conical flask in horizontal position driven by a motor on an open reactor. This system does not allow handling under a controlled atmosphere nor does it allow the mass of powder introduced to be recorded as a function of time. This system was described at the RC1 user forum in 1992 in San Antonio: “Computer controlled solids addition”. There is also a commercial system using an introduction loop controlled by a motor of RC1 type, comprising a helical screw. This system was described at the RC1 user forum in 1991, in Davos “Controlled solids addition to RC1 experiment”. This system is unable to record the mass of powder introduced as a function of time.

There are also some articulated arms systems.

The disadvantages with these systems are of two kinds: the difficulty in having precision over the quantity introduced as a function of time, and the difficulty of maintaining the sealing of the system. Indeed, in order to optimize a reaction before performing it on a larger scale it is important that all the parameters be mastered and their influences checked. To do that, reproducibility is needed. In addition, certain reactions are highly exothermic and the introduction of the reagents needs to be controlled in order to ensure maximum safety.

### DESCRIPTION OF THE INVENTION

The present invention makes it possible to solve the aforementioned disadvantages by producing a totally symmetric system characterized in that a first endless screw introduces the reagent into the reactor and a second screw, identical to the first but positioned in the opposite direction to the first, simultaneously introduces the same amount of reagent onto a balance. The balance thus records how much is introduced into the reactor in an indirect way. That makes it possible to determine what has been introduced, at what speed, and thus to discover the impact of the introduction of the powder on the reaction. In addition, the system can be produced in such a way that the reagent is introduced and stored under a controlled atmosphere. This system therefore allows a mass of reagent to be introduced under an atmosphere isolated from the outside in a way which is linear as a function of time or according to an introduction gradient. This system will also make it possible to program the introduction of the solid reagent. This system also allows this reagent to be introduced into a medium at any time, whether this medium be under vacuum, under pressure, bubbling or under a reactive gaseous atmosphere.

This apparatus for introducing solid reagents into a regulated reactor and which is reproducible over time is characterized in that it consists of two endless screws operating simultaneously and in the same way, the first delivering the solid reagent to the reactor and the second delivering the solid reagent to a balance. This apparatus can be used under a controlled atmosphere.

This apparatus is characterized in that the balance records the amount of reagent introduced as a function of time. This apparatus is used for optimizing chemical reactions.

This apparatus is a peripheral apparatus of a calorimetric reactor and can be fully controlled by any control system while at the same time maintaining the existing functionalities of the device.

The present invention is illustrated nonlimitingly using the following exemplary embodiment.

### BRIEF DESCRIPTION OF THE FIGURES

FIG. 1 depicts the apparatus in isolation; and

FIG. 2 depicts the apparatus mounted on the reactor for its use.

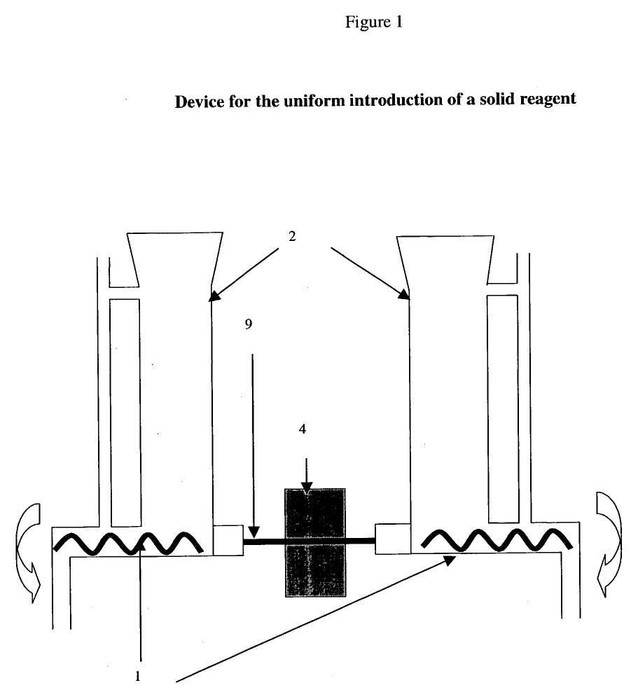

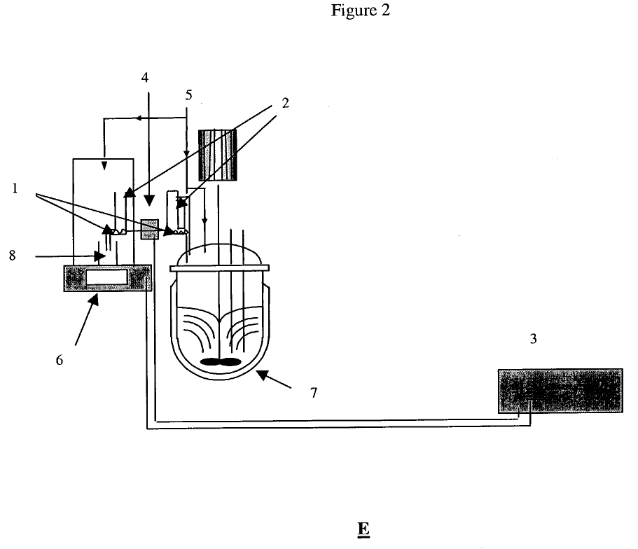

The key to FIGS. 1 and 2 is explained as follows: (1) Two teflon® screws of opposite hand; (2) Two glass reservoirs for the solid; (3) Motor control loop for introducing the powder; (4) Motor; (5) Gas inlet; (6) Balance; (7) Reactor; (8) Receiving container on the balance; and (9) Rotation shaft.

The apparatus consists of two teflon® screws (1), the flight of one is being of the opposite hand to that of the other, a rotation shaft (9) between the two screws and made of stainless steel inox®, an agitation motor (4) of the IKA 50-2000 rpm type for example, and powder reservoirs (2) made of glass resistant to vacuum and to pressure and having ground-in ends.

1. Apparatus for introducing solid reagents into a regulated reactor and which is reproducible over time, characterized in that it consists of two endless screws operating simultaneously and in the same way, the first delivering the solid reagent to the reactor and the second delivering the solid reagent to a balance.

2. An Apparatus according to claim 1, wherein introducing the solid reagents is carried out under a controlled atmosphere.

3. Apparatus according to claim 1, wherein the balance records the amount of reagent delivered as a function of time.

4. Use of the apparatus according to claim 1 for optimizing chemical reactions.
